(19) United States
(12) Patent Application Publication
(10) Pub. No.: US 2020/0380548 A1
(43) Pub. Date: Dec. 3, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventor: Ryo NEYAMA, Tokyo (JP)

(73) Assignee: TOYOTA JIDOSHA KABUSHIKI KAISHA, Toyota-shi (JP)

(21) Appl. No.: 16/881,058

(22) Filed: May 22, 2020

(30) Foreign Application Priority Data
May 27, 2019 (JP) 2019-098680

(51) Int. Cl. G06Q 30/02; H04W 4/40; H04W 4/024; G06Q 20/10; G01C 21/34

(52) U.S. Cl. CPC G06Q 30/0215; H04W 4/40; G01C 21/3407; G06Q 20/108; H04W 4/024

(57) ABSTRACT

An information processing apparatus that acquires environment information, which is information acquired with movement of a user, comprising a controller configured to execute the processing of selecting a first user who is to provide the environment information on the basis of first information, the first information being information relating to movement of the user, creating an incentive to be given to the first user when the first user provides the environment information, creating information about a route of travel along which the first user who receives the incentive is to travel, the route of travel being a route that enables the first user to acquire the environment information while travelling along this route, and sending information about the route of travel to a terminal of the first user who receives the incentive.

### CROSS REFERENCE TO RELATED APPLICATION

This application claims the priority to Japanese Patent Application No. 2019-098680, filed on May 27, 2019, which is hereby incorporated by reference herein in its entirety.

### BACKGROUND

### Technical Field

The present disclosure relates to an information processing apparatus, an information processing method, and a non-transitory storage medium.

### Description of the Related Art

There are known systems that include a center server configured to collect information acquired by running vehicles and provide services based on the collected information (see e.g. Patent Literature 1 in the citation list below).

### CITATION LIST

### Patent Literature

Patent Literature 1: Japanese Patent Application Laid-Open No. 2016-132368
Patent Literature 2: Japanese Patent Application Laid-Open No. 2017-004445
Patent Literature 3: Japanese Patent Application Laid-Open No. 2017-117154
Patent Literature 4: Japanese Patent Application Laid-Open No. 2017-199177
Patent Literature 5: Japanese Patent Application Laid-Open No. 2018-055191
Patent Literature 6: Japanese Patent Application Laid-Open No. 2018-055581

### SUMMARY

In such known systems, it takes time for the server to collect information about roads with low traffic. An object of the present disclosure is to provide a technology that enables acquisition of larger amount of information in shorter time.

According to one aspect of the present disclosure, there is provided an information processing apparatus that acquires environment information, which is information acquired with movement of a user, comprising a controller configured to execute the processing of: selecting a first user who is to provide the environment information on the basis of first information, the first information being information relating to movement of the user; creating an incentive to be given to the first user when the first user provides the environment information; creating information about a route of travel along which the first user who receives the incentive is to travel, the route of travel being a route that enables the first user to acquire the environment information while travelling along this route; and sending information about the route of travel to a terminal of the first user who receives the incentive.

According to another aspect of the present disclosure, there is provided an information processing method for acquiring environment information, which is information acquired with movement of a user, comprising the following processing executed by a computer: selecting a first user who is to provide the environment information on the basis of first information, the first information being information relating to movement of the user; creating an incentive to be given to the first user when the first user provides the environment information; creating information about a route of travel along which the first user who receives the incentive is to travel, the route of travel being a route that enables the first user to acquire the environment information while travelling along this route; and sending information about the route of travel to a terminal of the first user who receives the incentive.

According to another aspect of the present disclosure, there is provided a non-transitory storage medium storing a program for acquiring environment information, which is information acquired with movement of a user, the program being configured to cause a computer to execute the processing of: selecting a first user who is to provide the environment information on the basis of first information, the first information being information relating to movement of the user; creating an incentive to be given to the first user when the first user provides the environment information; creating information about a route of travel along which the first user who receives the incentive is to travel, the route of travel being a route that enables the first user to acquire the environment information while travelling along this route; and sending information about the route of travel to a terminal of the first user who receives the incentive.

According to another aspect of the present disclosure, there is provided the above program.

The present disclosure enables an information processing apparatus to acquire a larger amount of information in shorter time.

### BRIEF DESCRIPTION OF THE DRAWINGS

FIG. 1 is a diagram illustrating the general configuration of an information acquisition system according to an embodiment.

FIG. 2 is a block diagram illustrating exemplary configurations of an on-vehicle terminal, a center server, and a user server that constitute the information acquisition system according to the embodiment.

FIG. 3 is a diagram illustrating the functional configuration of the center server.

FIG. 4 is a diagram illustrating the functional configuration of the on-vehicle terminal.

FIG. 5 is a flow chart of a process executed by the center server to cause a vehicle to travel to acquire environment information.

FIG. 6 is a flow chart of an incentive giving process.

FIG. 7 is a flow chart of a process executed by the on-vehicle terminal to answer to a query as to acquisition of environment information.

FIG. 8 is a flow chart of a process executed by the on-vehicle terminal to acquire environment information.

FIG. 9 is a flow chart of a process executed by the center server to create map information.

### DESCRIPTION OF THE EMBODIMENTS

An information processing apparatus according to an embodiment of the present disclosure is configured to acquire environment information, which is information acquired with movement of a user. The environment information may be acquired by, for example, a sensor that a user's terminal has. The environment information may be linked with the time at which the environment information is acquired. The user's terminal may be a terminal carried by the user or a terminal provided in a vehicle which the user is aboard. An example of the environment information is image information needed to create a road map. Such a road map is used in, for example, a service categorized as Mobility-as-a-Service (MaaS) that provides autonomously-driven transportation means.

The controller of the information processing apparatus selects a first user who is to provide environment information, on the basis of first information relating to movement of the user. The first information is information indicative of the capability of acquiring environment information. Examples of the information relating to movement of a user include information about the present location of the user, information about a route along which the user is planned to travel, information about the destination of the user, and information about the time through which the user will travel. If the distance from the present location of the user or the planned route of travel of the user to a location at which environment information is to be acquired (which will be also referred to as a target location hereinafter) is too long, a loss for the user (e.g. time loss or economic loss) may result, or it may be difficult for the user to go to the target location. To avoid such situations from occurring, the controller selects an appropriate user who is to provide environment information, on the basis of the first information. The first user thus selected is not necessarily required to provide environment information. The first user may decline to acquire and provide environment information.

The controller creates an incentive given to the first user when the first user provides environment information. Thus, an incentive is given to the first user, if he/she provides environment information. Examples of the incentive include money, a discount coupon, a gift certificate, or a certain kind of point. The incentive given to the first user is beneficial to him/her. This facilitates recruiting of the first users, thereby promoting acquisition of environment information. Information about the incentive is created before the first user acquires environment information.

The controller creates information about a route of travel along which the first user who receives the incentive is to travel, the route of travel being a route that enables the first user to acquire environment information while travelling along this route. The controller sends information about the route of travel to a terminal of the first user who receives the incentive. The information about a route of travel includes information that enables the first user to get to a target location. For example, the information about a route of travel includes information about a route of travel from the present location of the first user to a destination via the target location. The first user can easily move to the target location at which information can be acquired, by travelling according to information about a route of travel sent from the controller. This also can promote acquisition of environment information.

The controller may execute the processing of sending information about the incentive to the terminal of the first user, sending information relating to a query as to whether or not the first user consents to travel along the route of travel to the terminal of the first user, and sending the information about the route of travel to the terminal of the first user who receives the incentive, if receiving information indicating that the first user consents to travel along the route of travel from the terminal of the first user.

As above, if the first user consents, he or she is invited to acquire environment information with an incentive given to him/her. This is beneficial to the first user. The controller may send information about a route of travel to the terminal of the first user without consent of him/her.

The controller may be configured to execute the processing of sending information about a loss for the first user that will result if the first user travels along the route of travel to the terminal of the first user.

It takes time for the first user to travel to the target location, and the travel to the target location will incur, for example, an increase in the fuel cost for the first user. There may be cases where the first user does not wish to travel to the target location considering such time loss and/or economic loss for the first user. Asking the first user whether to consent to travel along the route of travel with information of such losses helps the first user's decision. This increases the convenience of the user.

the controller may use information about the present location of the user as the first information to select as the first user a user whose present location is such that a location at which environment information is to be acquired is present within a predetermined range from the present location.

The predetermined range is an allowable range of travel of the user. This allowable range may be set based on, for example, the distance from the present location to the target location, the time taken for the user to travel from the present location to the target location, and/or the cost (e.g. fuel cost) incurred by travel from the present location to the target location. If the target location is located within the predetermined range from the present location of the user, the burden on the first user will remain in an allowable range even if the first user travels to the target location. If a user whose present location is such that the target location is present within the predetermined range from the present location is selected as the first user, the first user can easily go to the target location. Therefore, the first user will be likely to consent to acquire environment information.

The controller may use information about a route along which the user is planned to travel as the first information to select as the first user a user whose planned route of travel is such that a location at which environment information is to be acquired is included within a predetermined range from the planned route of travel.

In this case also, the predetermined range is an allowable range of travel of the user. This allowable range may be set based on, for example, the distance from the planned route of travel of the user to the target location, the time taken for the user to travel from the planned route of travel of the user to the target location, and/or the cost (e.g. fuel cost) incurred by travel from the planned route of travel of the user to the target location. If the target location is located within the predetermined range from the planned route of travel of the user, the burden on the first user will remain in an allowable range even if the first user travels via the target location. If a user whose planned route of travel is such that the target location is present within the predetermined range from the planned route of travel is selected as the first user, the first user can easily go to the target location. Therefore, the first user will be likely to consent to acquire environment information. The predetermined range may be set based on the increase in the travel distance of the user that will result from the change of the route from the planned route of travel to a route via the target location. The predetermined range may be set based on the increase in the time of travel of the user that will result from the change of the route from the planned route of travel to a route via the target location. The predetermined range may be set based on the increase in the cost for the user that will result from the change of the route from the planned route of travel to a route via the target location.

The controller may create the incentive in such a way that the higher the importance of the environment information is, the greater the incentive given to the first user is.

The importance of environment information may be the priority of acquisition of the environment information or the rarity of the environment information. For example, the number of user's terminals that can acquire environment information is small in roads with low traffic, and therefore the rarity of environment information acquired in such roads is high. In such cases, the importance of the environment information is evaluated high to make the incentive to the first user high, thereby facilitating recruiting of the first user. Likewise, if there is a road for which environment information has not been acquired sufficiently, the importance of environment information acquired in that road is evaluated high to make the incentive to the first user high, thereby facilitating recruiting of the first user. Thus, acquisition of environment information can be promoted.

As above, the controller may evaluate the importance of the environment information in such a way that the smaller the traffic volume at a location is, the higher the importance of the environment information acquired at that location is. Likewise, the controller may evaluate the importance of the environment information in such a way that the larger the amount of environment information needed to be acquired at a location is, the higher the importance of the environment information acquired at that location is. If information based on the environment information is provided to a second user, the controller may evaluate the importance of the environment information in such a way that the higher the fee received from the second user for that information is, the higher the importance of the environment information is.

When information based on the environment information is provided to a second user, the controller may create the incentive in such a way as to give a part of a fee received from the second user to the first user.

A portion of the profit may be returned to the first user in this way. The incentive may be given to the first user every time the second user uses the service. Alternatively, a constant incentive may be given to the first user irrespective of the number of times of use of the service.

In the following, an embodiment of the present disclosure will be described with reference to the drawings. The configuration of the embodiment described in the following is an illustrative example, and the present disclosure is not limited by the configuration of the embodiment. Features of the embodiment may be adopted in any feasible combinations.

### First Embodiment

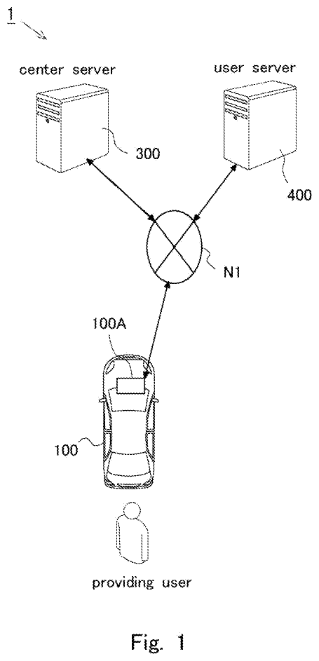

FIG. 1 is a diagram illustrating the general configuration of an information acquisition system 1 according to an embodiment. The exemplary information acquisition system 1 illustrated in FIG. 1 includes an on-vehicle terminal 100A provided in a vehicle 100, a center server 300, and a user server 400. The on-vehicle terminal 100A, the center server 300, and the user server 400 are interconnected by a network N1. The network N1 may be, a global public communication network, such as the Internet. A wide area network (WAN) or other communication network may be used as the network N1. The network N1 may include a telephone network, such as a cellular phone network and/or a wireless communication network, such as WiFi.

The information acquisition system 1 is a system configured to reduce information relating to the environment (or surroundings) of the vehicle 100 that the center server 300 has acquired from the on-vehicle terminal 100A and to provide the reduced information to the user server 400. In the following, information relating to the environment of the vehicle 100 that the center server 300 has acquired from the on-vehicle terminal 100A will also be referred to as environment information, and information created by reduction of environment information by the center server 300 will also be referred to as reduced information. The user server 400 may provide information to, for example, an autonomous vehicle. The information provided to the autonomous vehicle may be information necessary for autonomous driving, such as map information, an operation command, and/or a route guidance. An example of the environment information that the center server 300 acquires is image information captured by the on-vehicle terminal 100A. An example of the reduced information is map information created from the image information. While FIG. 1 shows only one vehicle 100 by way of example, the number of vehicles 100 included in the system is not limited to one. The information acquisition system 1 may include a plurality of vehicles 100. The on-vehicle terminal 100A may be either a terminal fixedly provided on the vehicle 100 or a terminal carried by a user. The vehicle 100 may be a connected car having the capability of external communication.

The center server 300 requests the on-vehicle terminal 100A to acquire environment information. The center server 300 sets an incentive according to, for example, the importance of the environment information and gives the incentive to the user who provides the environment information. The server informs the on-vehicle terminal 100A of the vehicle 100 requested to acquire environment information of a route to be followed to acquire environment information. Even when requested to acquire environment information by the center server 300, the user may decline the request considering the incentive and potential loss for the user. The on-vehicle terminal 100A is provided with a sensor or the like capable of acquiring environment information and communication device capable of sending the acquired environment information to the center server 300. The vehicle 100 goes by a location designated by the center server 300 to acquire environment information and sends the environment information to the center server 300 by the communication device. The center server 300 stores and analyses the environment information thus obtained and creates reduced information that is necessary in providing services.

The center server 300 collects from the user server 400 a fee for a service it provides to the user server 400. The center server 300 may provide reduced information directly to an autonomous vehicle or the like. A portion of the fee the center server 300 collects from the user server 400 may be used as an incentive given to users.

As above, the center server 300 gives an incentive to a user for acquisition of environment information. This can facilitate acquisition of environment information relating to a road by the center server 300 even if the traffic of the road is low.

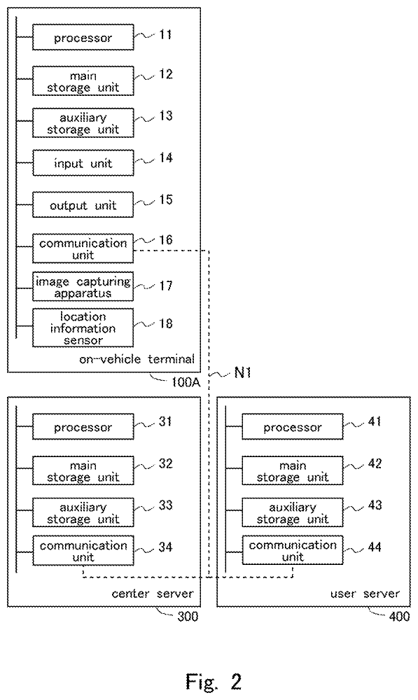

The hardware configuration of the on-vehicle terminal 100A, the center server 300, and the user server 400 will now be described with reference to FIG. 2. FIG. 2 is a block diagram schematically illustrating exemplary configurations of the on-vehicle terminal 100A, the center server 300, and the user server 400 that constitute the information acquisition system 1 according to the embodiment.

The center server 300 has a configuration as an ordinary computer. The center server 300 has a processor 31, a main storage unit 32, an auxiliary storage unit 33, and a communication unit 34. These components are interconnected by busses.

The processor 31 may include a CPU (Central Processing Unit), a DSP (Digital Signal Processor) or the like. The processor 31 controls the center server 300 and executes computation of various information processing. The processor 31 constitutes an example of the controller according to the present disclosure. The main storage unit 32 may include a RAM (Random Access Memory), a ROM (Read Only Memory) or the like. The auxiliary storage unit 33 may include an EPROM (Erasable Programmable ROM), a hard disk drive (HDD), a removable medium or the like. The auxiliary storage unit 33 stores an operating system (OS), various programs, and various tables. The processor 31 loads the programs stored in the auxiliary storage unit 33 into a workspace of the main storage unit 32 and executes the programs to control various components. Thus, the center server 300 implements functions for achieving desired purposes. The main storage unit 32 and the auxiliary storage unit 33 are computer-readable recording media. The center server 300 may be either a single computer or a plurality of computers that work cooperatively. Information or data stored in the auxiliary storage unit 33 may be stored in the main storage unit 32 instead. Information or data stored in the main storage unit 32 may be stored in the auxiliary storage unit 33 instead.

The communication unit 34 is means for communicating with the on-vehicle terminal 100A and the user server 400 via the network N1. The communication unit 34 may include a LAN (Local Area Network) interface board or a wireless communication circuit for wireless communication. The LAN interface board or the wireless communication circuit is connected to the network N1.

The processing executed by the center server 300 may be executed by either hardware or software.

The user server 400 has a configuration as an ordinary computer. The user server 400 has a processor 41, a main storage unit 42, an auxiliary storage unit 43, and a communication unit 44. These components are interconnected by busses. These components are similar to those in the center server 300 and will not be described further. The processor 41 of the user server 400 sends a request for map information and a request for routing to the center server 300. The processor 41 of the user server 400 also pays a fee for use of the system to the center server 300.

The on-vehicle terminal 100A will now be described. The on-vehicle terminal 100A has a processor 11, a main storage unit 12, an auxiliary storage unit 13, an input unit 14, an output unit 15, a communication unit 16, an image capturing apparatus 17, and a location information sensor 18. These components are interconnected by buses. The on-vehicle terminal 100A may be either a terminal fixedly mounted on the vehicle 100 or a small computer removable from the vehicle 100. Examples of such a removable small computer include a smartphone, a cellular phone, a tablet terminal, a personal information terminal, a wearable computer (such as a smartwatch), and a personal computer (PC). The processor 11, the main storage unit 12, and the auxiliary storage unit 13 are similar to the processor 31, the main storage unit 32, and the auxiliary storage unit 33 of the center server 300 respectively and will not be described further.

The input unit 14 is means for receiving input operations made by a user. Examples of the input unit 14 include a touch panel, a mouse, a keyboard, and a push button. The output unit 15 is means for presenting information to the user. Examples of the output unit 15 include a liquid crystal display (LCD), an electroluminescence (EL) panel, a speaker, and a lamp. The input unit 14 and the output unit 15 may be constituted by a single touch panel display. The communication unit 16 is communication means for connecting the on-vehicle terminal 100A to the network N1. An example of the communication unit 16 is a circuit that performs communication with another apparatus (e.g. the center server 300) via the network N1 using a mobile communication service, such as a telephone communication network based on 3G (3rd Generation) or LTE (Long Term Evolution) and wireless communication, such as WiFi.

The image capturing apparatus 17 is means for capturing images of the environment of the vehicle 100. An examples of the image capturing apparatus 17 is a camera that captures images using an image pickup device such as a CCD (Charge Coupled Device) or CMOS (Complementary Metal Oxide Semiconductor) image sensor. Images captured by the image capturing apparatus 17 may be either still images or moving images. The image capturing apparatus 17 may be a camera of a smartphone that the driver of the vehicle 100 has or a camera mounted on the vehicle 100.

The location information sensor 18 acquires location information of the vehicle 100 at predetermined intervals. The location information sensor 18 includes, for example, a GPS (Global Positioning System) receiver and a WiFi communication unit.

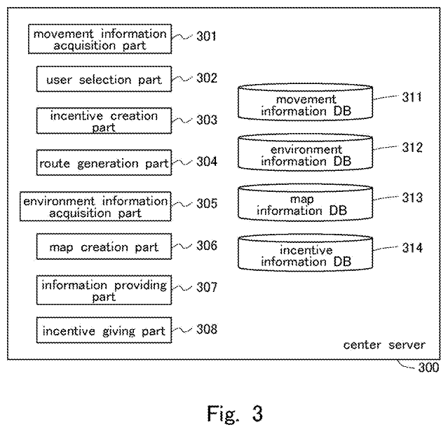

Functions of the center server 300 will now be described. FIG. 3 illustrates an exemplary configuration of the center server 300. The center server 300 includes, as functional components, a movement information acquisition part 301, a user selection part 302, an incentive creation part 303, a route generation part 304, an environment information acquisition part 305, a map creation part 306, an information providing part 307, an incentive giving part 308, a movement information database 311, an environment information database 312, a map information database 313, and an incentive information database 314. The processor 31 of the center server 300 executes the processing of the movement information acquisition part 301, the user selection part 302, the incentive creation part 303, the route generation part 304, the environment information acquisition part 305, the map creation part 306, the information providing part 307, and the incentive giving part 308 by computer programs running on the main storage unit 32. One or some of the above functional components or a part of the processing of them may be implemented by one or more hardware circuits.

The movement information database 311, the environment information database 312, the map information database 313, and the incentive information database 314 are created by managing data stored in the auxiliary storage unit 33 by a database management system program (DBMS program) executed by the processor 31. The movement information database 311, the environment information database 312, the map information database 313, and the incentive information database 314 are, for example, relational databases.

One or some of the above functional components of the center server 300 or a part of the processing of them may be implemented by another computer connected to the network N1.

The movement information acquisition unit 301 acquires movement information of the vehicle 100. The movement information is information relating to the movement of the vehicle 100, which may include information about the present location, the starting location, the destination, the travel route, and the date and time of travel of the vehicle 100. The movement information is sent, for example, from the on-vehicle terminal 100A to the center server 300. Information about the route of travel is generated by the route generation part 304, which will be specifically described later, on the basis of information about the starting location and the destination of the vehicle 100. The route of travel is a route along which the vehicle 100 is planned to travel afterward. After acquiring the movement information, the movement information acquisition part 301 stores it in the movement information database 311, which will be specifically described later.

The user selection part 302 selects a vehicle 100 or a user that is to acquire environment information. The user selection part 302 sends information relating to a query about the capability of acquiring environment information to on-vehicle terminals 100A of vehicles 100 whose present location or route of travel is such that a location at which environment information is to be acquired (i.e. target location) is present within a predetermined range from the present location or the route of travel. This information sent as a query will also be referred to as “query information” hereinafter. Then, the user selection part 302 selects a user associated with an on-vehicle terminal 100A that has answered in the affirmative to the query about the capability of acquiring environment information as the user that is to acquire the environment information. The aforementioned predetermined range is set in such a way that the time loss and/or economic loss for the user incurred by user's acquisition of environment information will remain within an allowable range. Alternatively, the user selection part 302 may select a user who can get to the target location at a time at which environment information is desired to be acquired.

When sending the query information to the on-vehicle terminal 100A, the user selection part 302 also sends information about an incentive for provision of environment information. The incentive is created by the incentive creation part 303, which will be specifically described later. When sending the query information, moreover, the user selection part 302 may also send information about time loss and/or economic loss that will be incurred by acquisition of environment information. The time loss and/or economic loss incurred by acquisition of environment information is, for example, time loss and/or economic loss that will result if the user (or the vehicle 100) moves from the present location to the target location. More specifically, the time loss is, for example, the time that will be taken if the user (or the vehicle) moves from the present location to the target location. The economic loss is, for example, the cost of fuel that will be consumed if the user (or the vehicle) moves from the present location to the target location.

Alternatively, the time loss and/or economic loss incurred by acquisition of environment information is, for example, time loss and/or economic loss that will result if the route of travel previously planned is changed to a route of travel that enables acquisition of environment information (which will also be referred to as the “changed route” hereinafter). More specifically, the time loss is, for example, the difference between the time that will be taken if the vehicle travels along the previously planned route and the time that will be taken if the vehicle travels along the changed route. The time that will be taken if the vehicle travels along the previously planned route and the time that will be taken if the vehicle travels along the changed route can be calculated from the expected average speeds of the vehicle in the respective routes and the lengths of the respective routes. The economic loss is, for example, the increase in the fuel cost resulting from the change of the route. The economic loss as such can be calculated from the increase in the travel distance and other factors. The user selection part 302 sends information about the changed route to the on-vehicle terminal 100A of the user who has answered in the affirmative to the query about the capability of acquiring environment information. The changed route is created by the route creation part 304, which will be specifically described later. When sending the information about the changed route, the user selection part 302 updates the movement information database 311 associated with the vehicle 100 to which the information is sent.

The incentive creation part 303 creates an incentive that will be given if the user acquires environment information. The incentive is a reward that will be given if the on-vehicle terminal 100A uploads environment information to the center server 300. Examples of the incentive include money, a discount coupon, a gift certificate, or a certain kind of point. The incentive may be determined according to the importance of environment information (e.g. its accuracy and/or rarity). Specifically, the incentive may be increased with increases in the importance of environment information, increases in the accuracy of environment information, and/or increases in the rarity of environment information. The incentive may be discounting or dispensing with the fee for use of route-finding service (e.g. the fee for requesting route-finding).

By way of example, let us consider a case where image information necessary for creating a static road map is to be acquired as environment information. In this case, the created road map constitutes reduced information. Here, it is assumed that a predetermined number of pieces of image information are necessary for every lane of every road to create a road map. Moreover, it is assumed by way of example that a road map that is necessary for autonomous vehicles to travel autonomously is to be created. The reward offered to the user is determined according to the statistical traffic volume of roads and/or the remaining number of pieces of image information necessary to create the road map. For example, roads with low traffic volume and/or roads for which the remaining number of pieces of image information (or the number of samples) necessary to create the road map is large may be considered to have greater importance, and higher rewards may be given to acquisition of image information about such roads. The traffic volume may be determined, for example, using statistical data. Even when the remaining number of pieces of image information of a road necessary to create the road map is small, image information of the road may be considered to have great importance, and a high reward may be given to acquisition of image information, if the road map is desired to be completed early. Clearer images would be acquired in a fine day and/or bright daytime; such images may be considered to have greater importance, and higher rewards may be given to acquisition of such images. In doing so, the incentive creation part 303 may obtain weather information from an external service. Images captured by cameras having higher performance (e.g. higher resolutions) would be clearer; such images may be considered to have greater importance, and higher rewards may be given to acquisition of such images. If the bandwidth of the communication unit 16 is large, larger amount of information can be sent in shorter time; image information sent by such communication unit 16 may be considered to have greater importance, and higher rewards may be given to acquisition of such image information. Cameras mounted at higher positions can capture images that are more useful for road map creation; image information acquired by buses or tracks, of which the position of the camera tends to be high, may be given higher rewards. Images with subject blur would lead to decreased accuracy of the road map; the reward may be determined according to the skill of the driver. The skill of the driver may be determined based on data of acceleration and deceleration and/or lateral acceleration and lateral deceleration in the past. For example, the reward to image information provided by drivers who tend to do harsh steering, sudden braking, and/or sudden acceleration may be lowered. The higher the fee paid for map information provided to the user server 400 or users is, the higher the importance of environment information associated with that map information may be considered to have, and the reward to the user may be determined accordingly.

The incentive creation part 303 stores information about the incentive it has created in the incentive information database 314 in association with the user. The incentive information database 314 will be specifically described later.

The route generation part 304 generates a route of travel that passes through the starting location and the destination of the user. The route of travel is generated based on the starting location and the destination of each user and map information stored in the map information database 313. The route of travel is generated as a route that is pursuant to predetermined rules. Examples of the route of travel as such include a route that makes the travel distance of the vehicle 100 shortest and a route that makes the travel time shortest. The route generation part 304 sends information about the generated route of travel to the on-vehicle terminal 100A. If the user consents to acquire image information, the route generation part 304 creates a changed route with the location at which image information is to be acquired (or the target location) being set as a place to be passed by.

The environment information acquisition part 305 acquires environment information sent from on-vehicle terminals 100A through the communication unit 34. The environment information acquisition part 305 stores the acquired environment information in the environment information database 312, which will be specifically described later.

The map creation part 306 stores and analyzes the environment information acquired by the environment information acquisition part 305 to create map information. A known method may be employed to create map information from environment information. The map creation part 306 stores the created map information in the map information database 313, which will be specifically described later. Moreover, the map creation part 306 sends information about places for which environment information is insufficient to create a map and information about the importance of environment information about such places to the user selection part 302.

The information providing part 307 provides map information created as above in response to a request from the user server 400 or the on-vehicle terminal 100A. The information providing part 307 may provide the map information to the route generation part 304, and information about the route of travel generated by the route generation part 304 may be provided to the user server 400 or the on-vehicle terminal 100A with the map information.

After receipt of image information from a user, the incentive giving part 308 consults the incentive information database 314 to give to the user an incentive associated with the user. The incentive may be given to the on-vehicle terminal 100A as electronic information or paid into a user's bank account registered in advance. Alternatively, the incentive giving part 308 may store information about the incentive in the auxiliary storage unit 33 so that the same user can use the incentive given this time as payment for use of map information by him/her on a later occasion. The incentive giving part 308 may give the incentive to a user's terminal registered in advance.

The time at which the incentive giving part 308 gives the incentive to the user is not limited to that in the above-described case. For example, the incentive may be given after another user or the user server 400 uses the map information and pays a fee for use of the information. Alternatively, the incentive giving part 308 may give the incentive to the user when the user requests the incentive giving part 308 to give the incentive through the on-vehicle terminal 100A.

The movement information database 311 is formed by movement information stored in the auxiliary storage unit 33, where pieces of movement information are linked with users. The movement information table for each user has the fields of user ID, present location, starting location, destination, date and time of travel, and route of travel. What is stored in the user ID field is identification data that specifies the user. Information about the user associated with the user ID (e.g. name, address, vehicle type, license number) is entered in the center server 300 in advance by the user through the on-vehicle terminal 100A.

What is stored in the present location field is information indicating the present location of the vehicle 100. The present location of the vehicle 100 is acquired by the location information sensor 18 of the vehicle 100 and sent from the on-vehicle terminal 100A to the center server 300 periodically. What is stored in the starting location field is information indicating the starting location of the vehicle 100. Information indicating the present location of the vehicle 100 may be stored in the starting location field. What is stored in the destination field is information indicating the destination of the vehicle 100. The present location, the starting location, and the destination are indicated by, for example, the latitude and longitude or address. What is stored in the date-and-time-of-travel field is information indicating the date and time of travel of the vehicle 100. What is stored in the route-of-travel field is information indicating the route along which the vehicle 100 is planned to travel.

The information about the starting location, the destination, and the date and time of travel is input by the user through the input unit 14 of the on-vehicle terminal 100A and sent from the communication unit 16 of the on-vehicle terminal 100A to the center server 300. The user inputs this information when requesting route-finding. The route of travel may be a route selected by the user from a plurality of possible travel routes generated by the route generation part 304.

The environment information table 312 stores environment information for every lane of every road, which is used for creating map information. The environment information database 312 is updated by the environment information acquisition part 305. Each piece of environment information is linked with the user who acquired it.

Examples of map information stored in the map information database 313 include link data relating to roads (or links), node data relating to nodes, intersection data relating to intersections, routing data for routing, facility data relating to facilities, and search data for searching locations. The map information database 313 is updated by the map creation part 306. Each piece of map information is linked with the user(s) who acquired environment information used to create that piece of map information.

The incentive information database 314 is formed by incentive information stored in the auxiliary storage unit 33. Pieces of incentive information are linked with users.

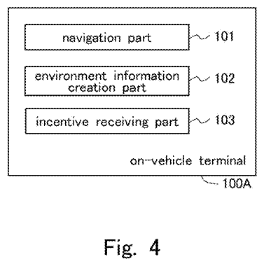

Functions of the on-vehicle terminal 100A will now be described. FIG. 4 is a diagram illustrating the functional configuration of the on-vehicle terminal 100A. The on-vehicle terminal 100A includes as functional components a navigation part 101, an environment information creation part 102, and an incentive receiving part 103. The processor 11 of the on-vehicle terminal 100A executes the processing of the navigation part 101, the environment information creation part 102, and the incentive receiving part 103 by computer programs running on the main storage unit 12. One or some of the above functional components or a part of the processing of them may be implemented by one or more hardware circuits.

The navigation part 101 displays a map around the present location of the vehicle 100 on the output unit 15 using map information stored in the auxiliary storage unit 13. When receiving information about a route of travel and map information from the center server 300, the navigation part 101 guides the route of travel of the vehicle 100 according to the information about the route of travel and the map information it has received. In doing so, the navigation part 101 outputs the map and the route of travel on the output unit 15 of the on-vehicle terminal 100A. For example, the navigation part 101 displays the map and the route of travel on a display and providing voice guidance to indicate the direction of travel according to the route of travel. Known technologies may be employed to implement functions of the navigation part 101.

While in the system according to the embodiment the route of travel is generated by the route generating part 304 of the center server 300, the route of travel may be generated by the navigation part 101 of the on-vehicle terminal 100A alternatively. In this alternative case, the center server 300 sends information about the location to be passed by to the on-vehicle terminal 100A, and the navigation part 101 creates a route of travel on the basis of the information about the starting location, the destination, and the location to be passed by and map information stored in the auxiliary storage unit 13. The map information stored in the auxiliary storage unit 13 is the same as the map information stored in the map information database 313 of the center server 300.

The environment information creation part 102 creates environment information in response to a request from the center server 300 and sends it to the center server 300. When receiving information relating to a query about the capability of acquiring environment information from the center server 300, the environment information creation part 102 outputs a query as to the capability of acquiring environment information on the output unit 15 to ask the user to enter an answer. When the user enters an answer through the input unit 14, the environment information creation part 102 sends information about the answer to the center server 300 through the communication unit 16. If the user answers that he/she can acquire environment information, the center server 300 sends information about a route of travel (changed route) that includes a location at which environment information is to be acquired, and the navigation part 101 provides guidance according to the changed route.

When the present location of the vehicle 100 coincides with the target location, the environment information creation part 102 controls the image capturing apparatus 17 to capture an image of the circumstances of the vehicle 100. The environment information creation part 102 sends the resultant image data to the center server 300 as environment information. The image data is sent with the user ID, information about the location at which the image data was acquired, and information about the incentive.

The incentive receiving part 103 receives information about an incentive (incentive information) from the center server 300. The incentive receiving part 103 stores the incentive information received from the center server 300 in the auxiliary storage unit 13. When receiving the incentive information from the center server 300, the incentive receiving part 103 may output a notice to that effect on the output unit 15. The incentive receiving part 103 may receive a notice of completion of payment into a user's bank account from the center server 300.

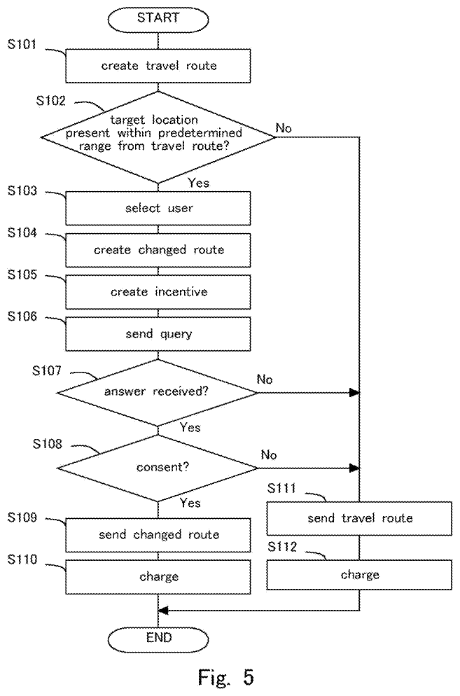

Now, a process of acquiring environment information executed in the center server 300 will be described. The center server 300 attempts to acquire environment information of locations at which environment information necessary for creating map information is insufficient. FIG. 5 is a flow chart of a process executed by the center server 300 to cause a vehicle 100 to move to acquire environment information. The process according to the flow chart of FIG. 5 is executed by the center server 300 every time a registered user requests the center server 300 to find a route of travel.

In step S101, the route generation part 304 generates a route of travel. When a user requests the center server 300 to find a route of travel, information about the starting location, the destination, and the time of travel is sent from the on-vehicle terminal 100A to the center server 300. The route generation part 304 generates a route of travel on the basis of the information about the starting location, the destination, and the time of travel. The route of travel thus generated is stored in the movement information database 311.

In step S102, the user selection part 302 determines whether or not a target location is present within a predetermined range from the route of travel generated in step S101. The target locations are set by the map creation part 306 beforehand on the basis of the environment information stored in the environment information database 312. In this step, the user selection part 302 may also determine whether or not the time of travel of the user is a time at which acquisition of environment information is desirable or falls within a certain length of time period during which acquisition of environment information is desirable. If an affirmative determination is made in step S102, the process proceeds to step S103. If a negative determination is made, the process proceeds to step S111.

In step S103, the user selection part 302 selects this user as a user that is to acquire environment information (i.e. first user). In step S104, the route generation part 304 generates a route of travel (i.e. changed route) that includes the target location. In step S105, the incentive creation part 303 creates information about an incentive to be given to the user. In step S106, the user selection part 302 sends information relating to a query as to whether or not the user consents to acquire environment information to the on-vehicle terminal 100A associated with the user selected in step S103 with the incentive information created by the incentive creation part 303 in step S105. In this step, the user selection part 302 may calculate a time loss and economic loss for the user that will be incurred and send the result of calculation to the on-vehicle terminal 100A additionally.

In step S107, the user selection part 302 determines whether or not it has received an answer to the query. If the user selection part 302 has not received an answer when a specific length of time has elapsed since when it sent information relating to the query, the user selection part 302 determines that it has not received an answer. If an affirmative determination is made in step S107, the process proceeds to step S108. If a negative determination is made, the process proceeds to step S111.

In step S108, the user selection part 302 determines whether or not the user's answer is a consent to acquisition of environment information. If an affirmative determination is made in step S107, the process proceeds to step S109. If a negative determination is made, the process proceeds to step S111. In step S109, the route creation part 304 sends information about the changed route generated in step S104 to the relevant on-vehicle terminal 100A. In step S110, the route creation part 304 charges the user. For example, the route creation part 304 debits a credit card account registered by the user in advance with a fee or deducts a fee from a bank account registered by the user in advance. Exemption of the charge in step S110 may be given as an incentive. In this case, the processing of S110 is eliminated.

In step S111, the route creation part 304 sends information about the route of travel created in step S101 to the relevant on-vehicle terminal 100A. This route of travel is a route that does not pass by the target location at which environment information is to be acquired. In step S112, the route creation part 304 charges the user.

While in this embodiment the center server 300 asks the user whether or not he/she consents to acquire environment information every time the user requests route-finding, the center server 300 may get a consent to acquisition of environment information in advance. More specifically, the center server 300 may store information about user's desired conditions in the auxiliary storage unit 33 and determine whether or not to invite the user to acquire environment information according to the user's desired conditions. For example, the center server 300 may be configured not to invite users who prefer wide roads or low traffic roads to acquire environment information in narrow roads or high traffic roads.

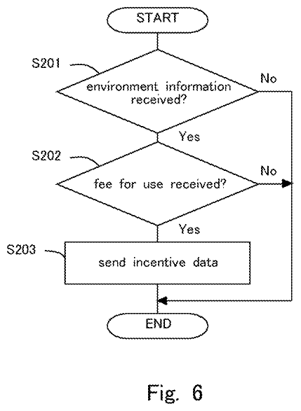

FIG. 6 is a flow chart of a process of giving an incentive to a user (incentive giving process). The process according to the flow chart of FIG. 6 is executed by the center server 300 for each of the selected users at predetermined intervals.

In step S201, the environment information acquisition part 305 determines whether or not it has received environment information from the selected user. If an affirmative determination is made in step S201, the process proceeds to step S202. If a negative determination is made, this routine is terminated. In step S202, the incentive giving part 308 determines whether or not it has already received a fee from the user server 400 or an on-vehicle terminal 100A that has used map information associated with the environment information received in step S201. Each piece of map information is linked with a piece of environment information and a user ID, and therefore the incentive giving part 308 can acquire the user ID linked with the map information. If an affirmative determination is made in step S202, the process proceeds to step S203. If a negative determined is made, this routine is terminated. In step S203, the incentive giving part 308 gives an incentive to the user. Specifically, the environment information is linked with the user ID, and the incentive giving part 308 sends information relating to an incentive to the on-vehicle terminal 100A associated with the user ID. The processing of step S202 is dispensable. In other words, when environment information is received, the incentive giving part 308 may send incentive data to the user who sent the environment information irrespective of whether or not a fee has received from the user server 400 or an on-vehicle terminal 100A.

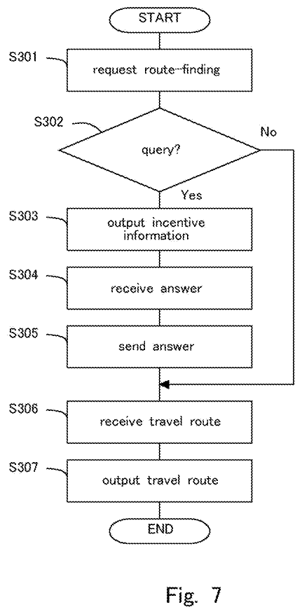

FIG. 7 is a flow chart of a process executed by the on-vehicle terminal 100A to answer to a query as to acquisition of environment information. The process according to the flow chart of FIG. 7 is executed by the on-vehicle terminal 100A when the user requests route-finding.

In step S301, the navigation part 101 sends information requesting route-finding to the center server 300. In doing so, the navigation part 101 sends information about the present location, the destination, and the time of travel of the vehicle 100 and the user ID to the center server 300. In step S302, the environment information creation part 102 determines whether or not it has received information relating to query as to consent to acquisition of environment information from the center server 300. If an affirmative determination is made in step S302, the process proceeds to step S303. If a negative determination is made, the process proceeds to step S306.

In step S303, the environment information creation part 102 causes the output unit 15 to display a screen based on the query information and the information about the incentive. If information about a time loss and/or economic loss that will result from potential change of the route of travel to a changed route has been received, the environment information creation part 102 may cause the output unit 15 to display this information also on the screen. The environment information creation part 102 causes, for example, a touch panel display to display radio buttons or the like allowing selection among answers to the query (consent or not consent). The environment information creation part 102 stores the incentive information in the auxiliary storage unit 13.

In step S304, the environment information creation part 102 generates information corresponding to an input by the user to the input unit 14 (i.e. information about the user's answer). If the user does not answer within a predetermined time, it is considered that the user does not consent to acquire environment information, and the environment information creation part 102 generates information about the user's answer to that effect. In step S305, the environment information creation part 102 sends the information about the user's answer to the center server 300. The environment information creation part 102 also sends information about the user ID and information about the incentive to the center server 300 with the information about the user's answer.

In step S306, the navigation part 101 receives information about a route of travel from the center server 300. In the case where the determination made in step S302 is negative, the route of travel received in step S306 does not include a location at which environment information is to be acquired (or a target location). In the case where the answer sent in step S305 is to the effect that the user does not consent to acquire environment information, the route of travel received in step S306 does not include a target location. On the other hand, in the case where the answer sent in step S305 is to the effect that the user consents to acquire environment information, the route of travel received in step S306 is the aforementioned changed route via a target location. In step S307, the navigation part 101 provides a display on the output unit 15 according to the route of travel received from the center server 300.

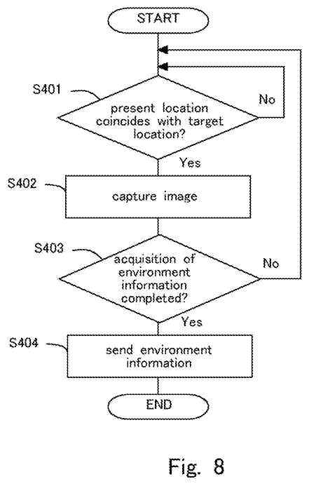

FIG. 8 is a flow chart of a process executed by the on-vehicle terminal 100A to acquire environment information. The process according to this flow chart is executed by the on-vehicle terminal 100A associated with a user who has consented to acquire environment information at predetermined intervals.

In step S401, the environment information creation part 102 determines whether or not the present location of the vehicle 100 coincides with the target location at which environment information is to be acquired. The present location of the vehicle 100 is acquired by the location information sensor 18. Information about the target location is included in the information about the changed route sent from the center server 300. If an affirmative determination is made in step S401, the process proceeds to step S402. If a negative determination is made, the processing of step S401 is executed again.

In step S402, the environment information creation part 102 captures an image of the surroundings of the vehicle 100 by the image capturing apparatus 17. Data of the captured image is stored in the auxiliary storage unit as environment information. In step S403, the environment information creation part 102 determines whether or not acquisition of environment information is completed. Environment information to be acquired is included in the information about the changed route sent from the center server 300. If an affirmative determination is made in step S403, the process proceeds to step S404. If a negative determination is made, the process returns to step S401. In step S404, the environment information creation part 102 sends the environment information stored in the auxiliary storage unit 13 to the center server 300. The environment information sent includes information about the user ID and information about the incentive.

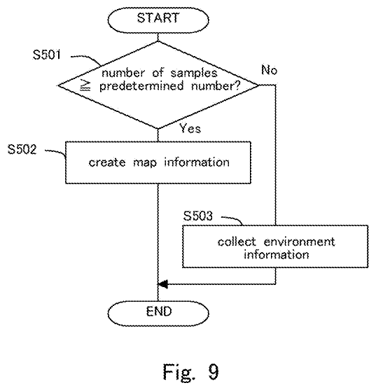

FIG. 9 is a flow chart of a process executed by the center server 300 to create map information. The process according to this flow chart is executed by the center server 300 for a location for which creation of map information has not been completed at predetermined intervals. In step S501, the map creation part 306 determines whether or not the number of pieces of environment information stored in the environment information database 312 (the number of samples) is equal to or more than a predetermined number. The predetermined number is the number of samples necessary for creating a map. Larger numbers of samples can lead to higher accuracy of the map but longer time taken to acquire samples. Therefore, the predetermined number is determined, for example, taking into account the accuracy of the map and the time taken to acquire samples. If an affirmative determination is made in step S501, the process proceeds to step S502. In step S502, the map creation part 306 creates map information. Known methods may be employed to create the map information. The map information created is linked with environment information and information about the user who acquired the environment information. If a negative determination is made in step S501, the process proceeds to step S503, where the center server 300 continues the collection of environment information. In other words, the location for which this process is being executed is regarded as a target location at which environment information is to be acquired in step S102 in the flow chart of FIG. 5.

As above, the system according to this embodiment can motivate users on vehicles 100 to move to locations at which environment information is to be acquired by giving incentives to them. This can promote acquisition of environment information. Thus, the system can acquire larger amount of environment information in shorter time.

### Other Embodiments

The above embodiment has been described only by way of example. Modifications can be made to the above embodiment without departing from the essence of the present disclosure.

While the information acquisition system according to the above embodiment acquires environment information for the purpose of creating a map, environment information may be acquired for the purpose of obtaining information relating to roads that is liable to change. For example, information about dynamically changing circumstances may be acquired, examples of which include suspensions of traffic of roads or lanes, traffic jams, obstacles, such as vehicles in trouble, and roads flooded by rain. In such cases, the center server 300 is configured to detect a location around which the movement of vehicles 100 is different than usual and to set this location as a target location. The center server 300 creates information about suspensions of traffic of roads or lanes, traffic jams, obstacles, such as vehicles in trouble, and roads flooded by rain as reduced information from image information. The center server 300 charges users who use route-finding service and are provided with the above information and gives incentives to users who provide environment information.

Alternatively, the information acquisition system may acquire information about parking lots as environment information. In this case, environment information is image information acquired by capturing a parking lot, and the system creates information about empty spaces of the parking lot as reduced information from the image information. The center server 300 sets parking lots that are to be checked as to the presence of empty spaces as target locations. The center server 300 charges users who are provided with information about empty spaces of parking lots and gives incentives to users who provide environment information. The center server 300 may provide simply image information as information about empty spaces of a parking lot.

The processing and means that have been described in the foregoing may be employed in any combination so long as it is technically feasible to do so.

A process described to be performed by one apparatus may be performed by a plurality of apparatuses in a distributed manner. A process described to be performed by different apparatuses may be performed by a single apparatus. The hardware configuration (server configuration) employed to implement various functions in a computer system may be modified flexibly.

The present disclosure can be carried out by supplying a computer program(s) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including a magnetic disc, such as a floppy (registered trademark) disc and a hard disk drive (HDD), and an optical disc, such as a CD-ROM, a DVD and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus that acquires environment information, which is information acquired with movement of a user, comprising a controller configured to execute the processing of:
selecting a first user who is to provide the environment information on the basis of first information, the first information being information relating to movement of the user;
creating an incentive to be given to the first user when the first user provides the environment information;
creating information about a route of travel along which the first user who receives the incentive is to travel, the route of travel being a route that enables the first user to acquire the environment information while travelling along this route; and
sending information about the route of travel to a terminal of the first user who receives the incentive.

2. An information processing apparatus according to claim 1, wherein the controller is configured to execute the processing of:
sending information about the incentive to the terminal of the first user;
sending information relating to a query as to whether or not the first user consents to travel along the route of travel to the terminal of the first user; and
sending the information about the route of travel to the first user who receives the incentive, if receiving information indicating that the first user consents to travel along the route of travel from the terminal of the first user.

3. An information processing apparatus according to claim 2, wherein the controller is configured to execute the processing of sending information about a loss for the first user that will result if the first user travels along the route of travel to the terminal of the first user.

4. An information processing apparatus according to claim 1, wherein the controller uses information about the present location of the user as the first information to select as the first user a user whose present location is such that a location at which the environment information is to be acquired is present within a predetermined range from the present location.

5. An information processing apparatus according to claim 1, wherein the controller uses information about a route along which the user is planned to travel as the first information to select as the first user a user whose planned route of travel is such that a location at which the environment information is to be acquired is present within a predetermined range from the planned route of travel.

6. An information processing apparatus according to claim 1, wherein the controller creates the incentive in such a way that the higher the importance of the environment information is, the greater the incentive given to the first user is.

7. An information processing apparatus according to claim 6, wherein the controller evaluates the importance of the environment information in such a way that the smaller the traffic volume of a location is, the higher the importance of the environment information acquired at that location is.

8. An information processing apparatus according to claim 6, wherein the controller evaluates the importance of the environment information in such a way that the larger the amount of environment information needed to be acquired at a location is, the higher the importance of the environment information acquired at that location is.

9. An information processing apparatus according to claim 1, wherein when information based on the environment information is provided to a second user, the controller creates the incentive in such a way as to give a part of a fee received from the second user to the first user.

10. An information processing method for acquiring environment information, which is information acquired with movement of a user, comprising the following processing executed by a computer:
selecting a first user who is to provide the environment information on the basis of first information, the first information being information relating to movement of the user;
creating an incentive to be given to the first user when the first user provides the environment information;
creating information about a route of travel along which the first user who receives the incentive is to travel, the route of travel being a route that enables the first user to acquire the environment information while travelling along this route; and
sending information about the route of travel to a terminal of the first user who receives the incentive.

11. A non-transitory storage medium storing a program for acquiring environment information, which is information acquired with movement of a user, the program being configured to cause a computer to execute the processing of:
selecting a first user who is to provide the environment information on the basis of first information, the first information being information relating to movement of the user;
creating an incentive to be given to the first user when the first user provides the environment information;
creating information about a route of travel along which the first user who receives the incentive is to travel, the route of travel being a route that enables the first user to acquire the environment information while travelling along this route; and
sending information about the route of travel to a terminal of the first user who receives the incentive.
